(19) United States
(12) Patent Application Publication
(10) Pub. No.: US 2020/0311230 A1
(43) Pub. Date: Oct. 1, 2020

(54) System and Method for Obtaining Authentication Credentials from Users

(71) Applicant: Google LLC, Mountain View, CA (US)

(72) Inventors: Andrew Taylor Sacamano, Munich (DE); Lee Waylon Calabrese, Lyons, CO (US)

(21) Appl. No.: 16/832,843

(22) Filed: Mar. 27, 2020

Related U.S. Application Data
(60) Provisional application No. 62/824,979, filed on Mar. 27, 2019.

(51) Int. Cl. G06F 21/31; G06F 21/44; G06F 21/62; G06F 16/14

(52) U.S. Cl. CPC G06F 21/31; G06F 16/144; G06F 21/6218; G06F 21/44

(57) ABSTRACT

A computing system for obtaining authentication credentials from users can be configured to perform operations. The operations can include receiving, at a user computing device from a server computing device, data describing a security query requesting an authentication credential; determining, by the user computing device, an input format for receiving a user input that describes the requested authentication credential; receiving, by the user computing device, the user input according to the input format determined by the user computing device, the user input describing the requested authentication credential; and transmitting, from the user computing device to the server computing device, data describing the requested authentication credential.

### CROSS REFERENCE TO RELATED APPLICATION

The present application claims filing benefit of U.S. Provisional Patent Application Ser. No. 62/824,979 having a filing date of Mar. 27, 2019, which is incorporated herein by reference in its entirety.

### FIELD

The present disclosure relates generally to distributed user authentication systems, and more specifically to a system and method for obtaining authentication credentials from users.

### BACKGROUND

Conducting transactions with user computing devices often involves exchanging credentials between the user computing devices and one or more server computing devices. Such exchanges, however, can be prone to safety issues, for example by tampering and/or infiltration by third parties. Further, server computing devices often lack information about the types of sensors and/or input devices with which various user computing are equipped. As such, transmitting requests for specific types of user input to input a requested authentication credential can be problematic.

### SUMMARY

Aspects and advantages of embodiments of the present disclosure will be set forth in part in the following description, or can be learned from the description, or can be learned through practice of the embodiments.

One example aspect of the present disclosure is directed to a computing system for obtaining authentication credentials from users. The computing system can include at least one processor and at least one tangible, non-transitory computer-readable medium that stores instructions that, when executed by the at least one processor, cause the at least one processor to perform operations. The operations can include receiving, at a user computing device from a server computing device, data describing a security query requesting an authentication credential; determining, by the user computing device, an input format for receiving a user input that describes the requested authentication credential; receiving, by the user computing device, the user input according to the input format determined by the user computing device, the user input describing the requested authentication credential; and transmitting, from the user computing device to the server computing device, data describing the requested authentication credential.

Another example aspect of the present disclosure is directed to a computer-implement method for obtaining authentication credentials from users. The method can include receiving, at a user computing device from a server computing device, data describing a security query requesting an authentication credential; determining, by the user computing device, an input format for receiving a user input that describes the requested authentication credential; receiving, by the user computing device, the user input according to the input format determined by the user computing device, the user input describing the requested authentication credential; and transmitting, from the user computing device to the server computing device, data describing the requested authentication credential.

Another example aspect of the present disclosure is directed to a computing system for obtaining authentication credentials from users. The computing system can include at least one processor and at least one tangible, non-transitory computer-readable medium that stores instructions that, when executed by the at least one processor, cause the at least one processor to perform operations. The operations can include receiving, at a first server computing device from a second server computing device, first data describing a security query requesting an authentication credential; transmitting, from the first server computing device to a user computing device, second data describing the security query requesting the authentication credential, wherein the first data describing the requested authentication credential comprises secure semantic data that differs from the second data describing the requested authentication credential; determining, by the user computing device, an input format for receiving a user input that describes the requested authentication credential; and receiving, by the user computing device, the user input according to the input format determined by the user computing device, the user input describing the requested authentication credential.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system for receiving data describing an electronic item according to example embodiments of the present disclosure.

FIG. 2 depicts a block diagram of another example computing system for receiving data describing an electronic item according to example embodiments of the present disclosure.

FIG. 3 depicts a block diagram of an another example computing system that includes multiple server computing devices according to example embodiments of the present disclosure.

FIG. 4 depicts a flow chart diagram of an example method for receiving data describing an electronic item according to aspects of the present disclosure.

FIG. 5 depicts a flow chart diagram of an example method for receiving data describing an electronic item according to aspects of the present disclosure.

FIG. 6 is a block diagram depicting of an example computing system that includes multiple server computing devices and in which the user is accessing a web browser application according to example embodiments of the present disclosure.

FIG. 7 is a block diagram depicting of an example computing system that includes multiple server computing devices and in which the user is accessing a voice assistant according to example embodiments of the present disclosure.

FIG. 8 is a block diagram depicting of an example computing system that includes multiple server computing devices and in which the user is accessing a smartphone according to example embodiments of the present disclosure.

Reference numerals that are repeated across plural figures are intended to identify the same features in various implementations.

### DETAILED DESCRIPTION

### Overview

Generally, the present disclosure is directed to systems and methods for obtaining authentication credentials from users. The system can be configured to receive, at a user computing device from a server computing device, data describing a security query requesting an authentication credential. For example, a shopping website or a banking platform operated by the server computing device can transmit the security query to the user computing device. The system can determine, by the user computing device, an input format for receiving a user input that describes the requested authentication credential. The authentication credentials can be required by the server computing device to complete an online payments and/or transaction. Example authentication credentials include passwords, personal identification numbers (PINs), answers to security questions, and the like. Various user computing devices can have differing input capabilities and/or sensors, such as touchscreens, various physical button configurations, joysticks, accelerometers, and/or other types of sensors. Example user computing devices include desktop computers, laptop computers, gaming consoles, gaming controllers, smart watches, smart phones, smart televisions, set top boxes, tablets, voice assistant devices, and various other devices. As such, suitable input formats for the user to input their authentication credentials can vary between different user computing devices. For example, a gaming console may include an accelerometer and a limited number of physical buttons without a touchscreen. Traditional authentication procedures for third-party computing systems associated with banking institutions and the like may not be specifically designed for these type of systems to receive the requested user information.

Accordingly, embodiments in accordance with the present disclosure provide techniques that enable third-parties to request and receive authentication credentials through various types of user computing devices. More particularly, the described techniques allow third-party computing systems to request and receive authentication credentials through various types of user computing devices without requiring the third-party computing system to tailor its requests for a particular type of user computing device. For example, a user can input authentication credentials by pressing one or more of the physical buttons and/or moving a gaming console/controller according to a movement gesture (if the gaming console is equipped with an accelerometer or other motion sensor). As another example, the user can input authentication credentials by moving a joystick of the user computing device in an input sequence that describes the user's authentication credentials. The user computing device can receive a request associated with a third-party computing system and determine an appropriate input format for receiving the requested information from a user. The system can receive, by the user computing device, the user input according to the format determined by the user computing device. The system can transmit, from the user computing device to the server computing device, data describing the requested authentication credential. Thus, the system can facilitate user input that describes the requested authentication credential in a format that is suitable and/or optimized for the user device.

The data describing the security query which requests the authentication credential can include a variety of data types and/or formats. For example, the data describing the security query can include semantic elements of a challenge question for the user. One example data format for such semantic elements of a challenge question is a 3-D Secure (“3DS”) challenge. 3DS is an XML-based protocol designed to be an additional security layer for online credit and debit card transactions. Such 3-D Secure (“3DS”) challenges can be adaptable in other data formats (e.g., HTML5), but can be expressed semantically. Aspects of the present disclosure can facilitate semantic challenges (e.g., 3DS challenges) in a way that provides strong brand fidelity, is safe in sensitive contexts, can be readily rendered while complying with various platforms standards. For example, allowing the user computing device to determine the format for receiving user input that describes the requested authentication credential, as described herein, can facilitate such semantic challenges in this manner.

The technology disclosed herein can be used to balance the expressiveness of markup languages (e.g., modern HTML) and/or style sheet language (e.g., cascading style sheets (“CSS”)) with the complexity of rendering that expressiveness using native elements. For example, semantic elements of a security query can be converted into a subset of HTML and/or CSS. The subset can be defined with respect to particular commands, particular subroutines, and/or other constraints. This conversion can occur at a server computing device (e.g., that facilitates a shopping website or platform).

In some embodiments, multiple server computing devices and/or systems can communicate and/or facilitate obtaining authentication credentials form a user. For example, a first server computing device can facilitate a shopping website, application, platform, digital storefront, or the like. A second server computing device (e.g., additional server computing device) can be operated by and/or facilitate banking and/or financial services. The first server computing device may be optimized for procuring authentication credentials from the user computing device. The second server computing device, however, may not be optimized for procuring authentication credentials from the user computing device, especially as new user computing devices and device types are developed.

In one example, the additional server computing device can be operated by the user's bank, credit card issuer, or other institution involved in a transaction such as a financial transaction where sensitive user data may be exchanged. The user can access, using a user computing device, the shopping website that is facilitated by the server computing device. The user can select an item for purchase and proceed to checkout. At checkout, the second server computing device 306 (e.g., additional server computing device) can transmit first data to the first server computing device 304, which can provide or maintain the shopping website. The first data can describe a security query requesting an authentication credential.

The system can transmit, from the first server computing device to the user computing device, second data describing the security query requesting the authentication credential. The second data can differ from the first data. The second data can be or include data of a different type and/or format than the first data. For example, the first data can be or include secure semantic data (e.g., 3-D Secure data) describing the security query. The second data can include markup languages (e.g., modern HTML) and/or style sheet language (e.g., cascading style sheets (“CSS”)). The second data can include or describe formatting information for how the user computing device requests the authentication credentials from the user. For example, the second data can describe an appearance of text (e.g., font, location, etc.) for display by the user computing device. As another example, the second data can describe an intonation of words to be played aloud by the user computing device (e.g., voice assistant application of the user computing device).

In some embodiments, the first server computing device can determine the data format for the second data based on one or more characteristics of the user computing device. Example characteristics can include a sensor configuration, an operating system type, a processing capability, a memory capability, and/or characteristics of a data connection with the user computing device. As an example, the first server computing device can determine that the data format for the second data should include markup languages and/or style sheet languages based on the user computing device being a desktop computer or a laptop computer that is running a web browser application. As another example, the server computing device can determine that the data format for the second data should include data describing text to be dictated and/or describing a vocal intonation for such dictation based on the user computing device being or including a voice assistant. One example voice assistant can be provided by a home voice assistant device that lacks a display screen. As a further example, the server computing device can determine that the data format for the second data should include secure semantic data based on the user computing device being or including a smartphone or a tablet (e.g., accessing the server computing device via an application of the user computing device). Secure semantic data can be more appropriate in such an instance, for example, because the application can interpret and/or decode the secure semantic data.

In some embodiments, the input format for receiving the user input that describes the requested authentication credential comprises referencing a preferred input format defined by a manufacturer of the user computing device. The manufacturer can define the preferred input format based on an input sensor configuration of the user computing device and/or another characteristic of the user computing device. For example, the preferred input format for a gaming console controller can include providing an input sequence of physical buttons and/or performing a movement gesture (if the gaming console controller includes an accelerometer or other movement sensor). As another example, the preferred input format for a voice assistance device can include dictation. As a further example, the preferred input format for a wheelchair controller can include an input sequence with respect to an input device connected with the wheelchair controller (e.g., a keypad, joystick, eye-tracking controllers, or other input devices for controlling movement of the wheelchair and/or inputting data with respect to the wheelchair controller).

In some embodiments, the input format for receiving the user input that describes the requested authentication credential can be selected based on a user preference. For example, the user computing device can determine the input format based on a user preference with respect to inputting authentication credentials. For example, if a user has generally shown a preference for inputting authentication credentials by dictation, then the user computing device can select an input format that includes dictation based on the user's preference. As another example, the user computing device can select an input format that includes a movement gesture based on a user's preference for inputting authentication credentials using movement gestures. Thus, in some embodiments, the input format for receiving the user input that describes the requested authentication credential can be selected based on a user preference.

The systems and methods of the present disclosure can provide multiple technical effects and benefits. Aspects of the present disclosure can facilitate inputting authentication credentials for people with disabilities and/or requiring assistance. For example, a robotic wheelchair can include a wheelchair controller for controlling movement of the wheelchair. The wheelchair controller can determine an input format for receiving user input that describes a requested authentication credential. As such, the wheelchair controller can be configured to receive user input in a manner that is suitable for the user and/or to which the user is accustomed. This may be particularly useful for people having impaired hand dexterity and/or limb mobility such that other input formats (e.g., typing on a physical keyboard or a virtual keyboard on a touch screen) may not be feasible or appropriate.

Aspects of the present disclosure can additionally facilitate improved ease of user input for authentication credentials.

Additionally, aspects of the present disclosure can reduce or eliminate customization and/or tailoring (e.g., by financial instructions, such as banks, credit card providers, etc.) requests for sensitive information, such as authentication requests (e.g., data formatting thereof). As such, cross-platform compatibility can be improved and/or facilitated between financial instructions, shopping platforms, and/or end users. Such compatibility can improve reliability. For example, reliability can be improved by reducing or eliminating the probability that that an authentication request is not properly interpreted and/or conveyed to the user by the user computing device because of formatting capabilities.

Additionally, aspects of the present disclosure can reduce or eliminate customization and/or tailoring (e.g., by shopping services, such as shopping website providers, shopping platforms, etc.) for requests user input format for sensitive information, such as authentication requests. As described herein the user computing device can determine an appropriate user input format in response to receiving a request for authentication information (e.g., from a shopping website). The request for authentication can be agnostic with respect input format, thereby reducing and/or eliminating the need for customization and/or tailoring of such requests for device-specific characteristics. As such, cross-platform compatibility can also be improved with respect to user input format.

Additional technical effects and benefits can include providing improved security against third parties interfering with data transmission between the server computing devices and/or user computing device. For example, transmission of more tamper-susceptible data formats (e.g., markup languages such as HTML and/or style sheet language formats) can be reduced and/or eliminated through conversion of the data formats at the first server, for example as discussed above with reference to FIG. 3. As such, re-transmission of such data formats can be avoided (e.g., by the first server), which can otherwise be susceptible to tampering by third parties. Thus, aspects of the present disclosure can improve security with respect to sensitive data transmission.

With reference now to the Figures, example embodiments of the present disclosure will be discussed in further detail.

### Example Devices and Systems

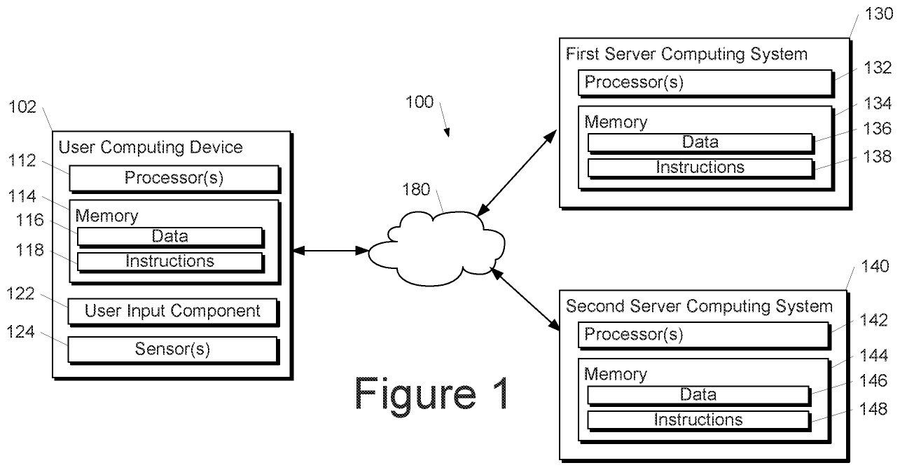

FIG. 1 depicts a block diagram of an example computing system 100 for receiving data describing an electronic item according to example embodiments of the present disclosure. The system 100 can include a user computing device 102 and a server computing device 130 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations. Electronic items and/or data describing electronic items can be stored in one more local memory locations of the user computing device 102. For example, the local memory location can correspond with the memory 114.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication. The user computing device 102 can also include one or more sensors 124, such as microphones, cameras, temperature sensors, accelerometers, and the like. Additional example user input components 122 can include physical buttons, joysticks, accelerometers, microphones, and/or other types of sensors.

The server computing device 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing device 130 to perform operations.

In some implementations, the server computing device 130 includes or is otherwise implemented by one or more server computing devices. In instances in which the server computing device 130 includes plural server computing devices, such server computing devices can operate according to sequential computing architectures, parallel computing architectures, or some combination thereof.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### Example Embodiments

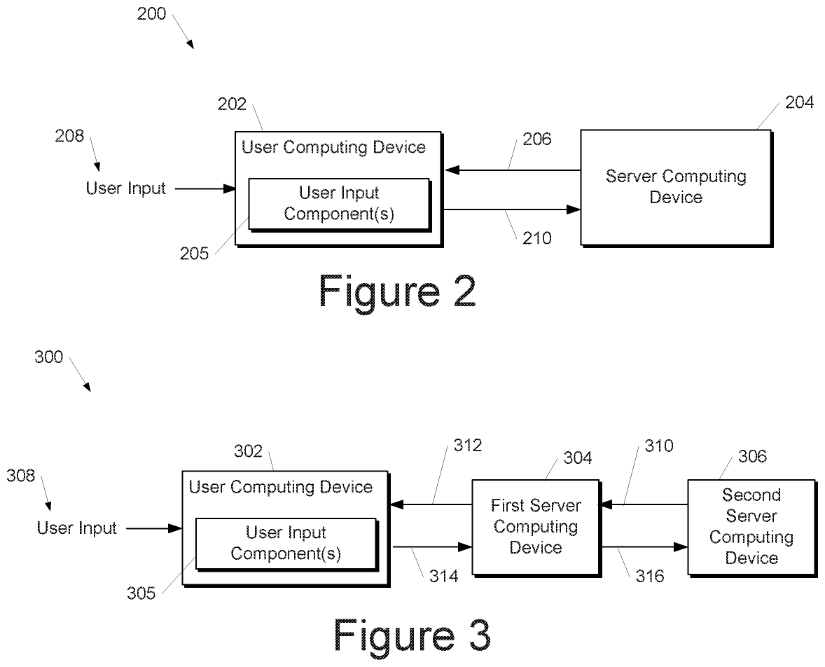

FIG. 2 depicts a block diagram of an example computing system 200 according to example embodiments of the present disclosure. The computing system 200 can include a user computing device 202 and a server computing device 204. The user computing device 202 can receive data 206 describing a security query requesting an authentication credential from the server computing device 204. The authentication credentials can be required by the server computing device 204 to complete an online payments and/or transaction. Example authentication credentials include passwords, personal identification numbers (PINs), answers to security questions, and the like.

The data 206 describing the security query which requests the authentication credential can include a variety of data types and/or formats. For example, the data 206 describing the security query can include semantic elements of a challenge question for the user. One example data format for such semantic elements of a challenge question is a 3-D Secure (“3DS”) challenges. 3DS is an XML-based protocol designed to be an additional security layer for online credit and debit card transactions. Such 3-D Secure (“3DS”) challenges can be adaptable in other data formats (e.g., HTML5), but can be expressed semantically. Aspects of the present disclosure can facilitate semantic challenges (e.g., 3DS challenges) in a way that provides strong brand fidelity, is safe in sensitive contexts, can be readily rendered while complying with various platforms standards. For example, allowing the user computing device 202 to determine the format for receiving user input 208 that describes the requested authentication credential, as described herein, can facilitate such semantic challenges in this manner.

The user computing device 202 can determine an input format for receiving the user input 208 that describes the requested authentication credential. The user computing device 202 can include one or more user input components 205, for example as described above with reference to the user input component(s) 124 of FIG. 1. Example user input component(s) 205 can include touchscreens, various physical button configurations, joysticks, accelerometers, and/or other types of sensors. Example user computing devices 202 include desktop computers, laptop computers, gaming consoles, gaming controllers, smart watches, smart phones, smart televisions, set top boxes, tablets, voice assistant devices, and various other devices. As such, suitable input formats for the user to input their authentication credentials can vary between different user computing devices 202. For example, a gaming console may include an accelerometer and a limited number of physical buttons without a touchscreen. The user can provide the user input 208 that describes the authentication credentials by pressing one or more of the physical buttons and/or moving the gaming console (user computing device 202) according to a movement gesture if the gaming console (user computing device 202) is equipped with an accelerometer or other motion sensor. As another example, the user can provide the user input 208 that describes the input authentication credentials by moving a joystick of the user input component(s) 205 of the user computing device 202 in an input sequence that describes the user's authentication credentials. The system 200 can receive, by the user computing device 202, the user input 208 according to the format determined by the user computing device 202. The system 200 can transmit, from the user computing device 202 to the server computing device 204, data 210 describing the requested authentication credential. Thus, the system 200 can facilitate the user input 208 that describes the requested authentication credential in a format that is suitable and/or optimized for the user computing device 202.

The user computing device 202 can receive the user input 208 according to the input format determined by the user computing device 202. The user input 208 can describe the requested authentication credential. The user computing device 202 can transmit the data 210 describing the requested authentication credential to the server computing device 204.

In some embodiments, the input format for receiving the user input 208 that describes the requested authentication credential comprises referencing a preferred input format defined by a manufacturer of the user computing device 208. The manufacturer can define the preferred input format based on a configuration of the user input components(s) 205 of the user computing device 202 and/or another characteristic of the user computing device 208. For example, the preferred input format for a gaming console controller can include providing an input sequence of physical buttons and/or performing a movement gesture (if the gaming console controller includes an accelerometer or other movement sensor). As another example, the preferred input format for a voice assistance device can include dictation. As a further example, the preferred input format for a wheelchair controller can include an input sequence with respect to an input device (e.g., the user input component(s) 205) connected with the wheelchair controller (e.g., user computing device 202), such as a keypad, joystick, eye-tracking controllers, or other input devices for controlling movement of the wheelchair and/or inputting data with respect to the wheelchair controller.

In some embodiments, the input format for receiving the user input 208 that describes the requested authentication credential can be selected based on a user preference. For example, the user computing device 202 can determine the input format based on a user preference with respect to inputting authentication credentials. For example, if a user has generally shown a preference for inputting authentication credentials by dictation, then the user computing device 208 can select an input format that includes dictation based on the user's preference. As another example, the user computing device 208 can select an input format for the user input 208 that includes a movement gesture based on a user's preference for inputting authentication credentials using movement gestures. Thus, in some embodiments, the input format for receiving the user input 208 that describes the requested authentication credential can be selected based on a user preference.

FIG. 3 depicts a block diagram of an example computing system 300 including multiple server computing devices according to example embodiments of the present disclosure. For example, a first server computing device 304 can facilitate a shopping website, application, platform, digital storefront, or the like. A second server computing device 306 (e.g., additional server computing device) can be operated by and/or facilitate banking and/or financial services. The first server computing device 304 may be optimized for procuring authentication credentials from the user computing device 302. The second server computing device 306, however, may not be optimized for procuring authentication credentials from the user computing device 302, especially as new user computing devices 302 and device types are developed.

In one example, the second server computing device 306 can be operated by the user's bank. The user can access, using the user computing device 302, the shopping website that is facilitated by the first server computing device 304. The user can select an item for purchase and proceed to checkout. At checkout, the second server computing device 306 can transmit first data 310 to the first server computing device 304. The first data 310 can describe a security query requesting an authentication credential.

The system 300 can transmit, from the first server computing device 304 to the user computing device 302, second data 312 describing the security query requesting the authentication credential. The second data 312 can differ from the first data 310. The second data 312 can be or include data of a different type and/or format than the first data 310. For example, the first data 310 can be or include secure semantic data (e.g., 3-D Secure data) describing the security query. The second data 312 can include markup languages (e.g., modern HTML) and/or style sheet language (e.g., cascading style sheets (“CSS”)). The second data 312 can include or describe formatting information for how the user computing device 302 requests the authentication credentials from the user. For example, the second data 312 can describe an appearance of text (e.g., font, location, etc.) for display by the user computing device 302. As another example, the second data 312 can describe an intonation of words to be played aloud by the user computing device 302 (e.g., voice assistant application of the user computing device 302).

In some embodiments, the first server computing device 304 can determine the data format for the second data 312 based on one or more characteristics of the user computing device 302. Example characteristics can include a sensor configuration, an operating system type, a processing capability, a memory capability, and/or characteristics of a data connection with the user computing device 302. As an example, the first server computing device 304 can determine that the data format for the second data 312 should include markup languages and/or style sheet languages based on the user computing device 302 being a desktop computer or a laptop computer that is running a web browser application. As another example, the first server computing device 304 can determine that the data format for the second data 312 should include data describing text to be dictated and/or describing a vocal intonation for such dictation based on the user computing device 302 being or including a voice assistant. One example voice assistant can be provided by a home voice assistant device that lacks a display screen. As a further example, the first server computing device 304 can determine that the data format for the second data 312 should include secure semantic data based on the user computing device 302 being or including a smartphone or a tablet (e.g., accessing the server computing device via an application of the user computing device). Secure semantic data can be more appropriate in such an instance, for example, because the application can interpret and/or decode the secure semantic data.

The user computing device 302 can transmit third data 314 describing the requested authentication credential to the first computing device 304. The first server computing device 304 can transmit fourth data 316 from the first server computing device 304 to the second server computing device 306 to facilitate and/or conduct the transaction.

### Example Methods

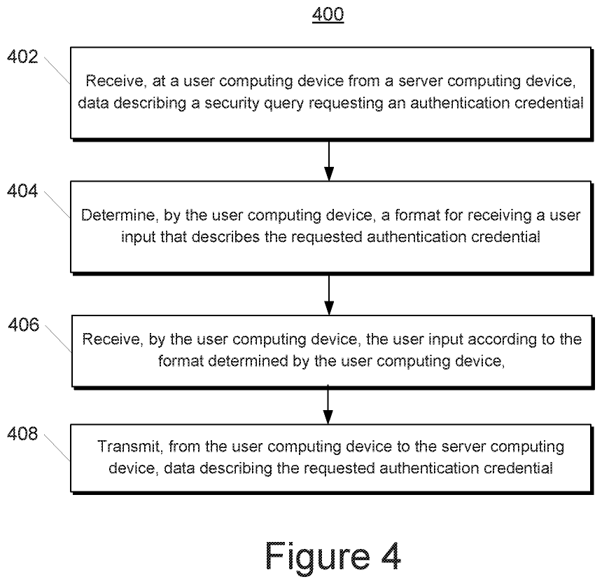

FIG. 4 depicts a flow chart diagram of an example method for obtaining authentication credentials from users. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, the method 400 can include receiving, at a user computing device from a server computing device, data describing a security query requesting an authentication credential, for example as described above with reference to the data 206, 312 described above with reference to FIGS. 2 and 3.

At 404, the method 400 can include determining, by the user computing device, an input format for receiving a user input that describes the requested authentication credential. The input format can be selected by referencing a preferred input format defined by a manufacturer of the user computing device. The manufacturer can define the preferred input format based on an input sensor configuration of the user computing device and/or another characteristic of the user computing device. In some embodiments, the input format for receiving the user input that describes the requested authentication credential can be selected based on a user preference. Thus, in some embodiments, the input format for receiving the user input that describes the requested authentication credential can be selected based on a preferred input format defined by the manufacturer of the user computing device and/or based on a user preference.

At 406, the method 400 can include receiving, by the user computing device, the user input according to the input format determined by the user computing device, the user input describing the requested authentication credential, for example as described above with reference to FIGS. 2 and 3.

At 406, the method 400 can include transmitting, from the user computing device to the server computing device, data describing the requested authentication credential, for example as described above with reference to FIGS. 2 and 3.

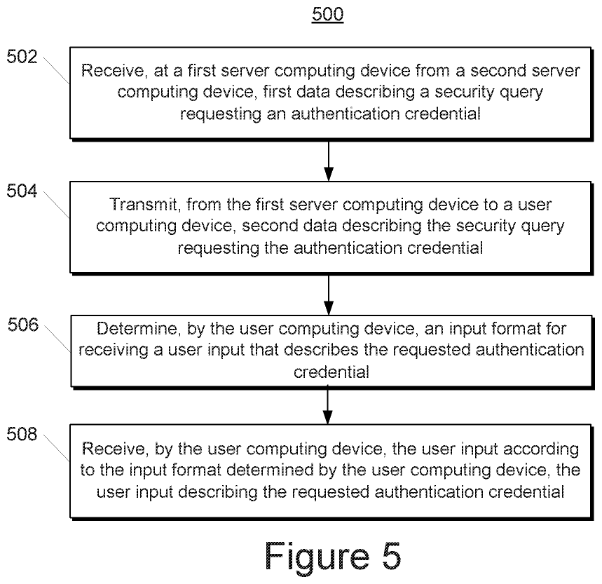

FIG. 5 depicts a flow chart diagram of another example method 500 for obtaining authentication credentials from users. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, the method 500 can include receiving, at a first server computing device from a second server computing device, first data describing a security query requesting an authentication credential, for example as described above with reference to FIG. 4.

For example, the first server computing device can facilitate a shopping website, application, platform, digital storefront, or the like. The second server computing device (e.g., additional server computing device) can be operated by and/or facilitate banking and/or financial services. In one example, the second server computing device can be operated by the user's bank. The user can access, using the user computing device, the shopping website that is facilitated by the first server computing device. The user can select an item for purchase and proceed to checkout. At checkout, the second server computing device can transmit first data to the first server computing device. The first data can describe a security query requesting an authentication credential.

At 504, the method 500 can include transmitting, from the first server computing device to a user computing device, second data describing the security query requesting the authentication credential. The first data describing the requested authentication credential can include secure semantic data that differs from the second data describing the requested authentication credential. For example, the first data can be or include secure semantic data (e.g., 3-D Secure data) describing the security query. The second data can include markup languages (e.g., modern HTML) and/or style sheet language (e.g., cascading style sheets (“CSS”)). The second data can include or describe formatting information for how the user computing device requests the authentication credentials from the user. For example, the second data can describe an appearance of text (e.g., font, location, etc.) for display by the user computing device. As another example, the second data can describe an intonation of words to be played aloud by the user computing device (e.g., voice assistant application of the user computing device).

In some embodiments, the first server computing device can determine the data format for the second data based on one or more characteristics of the user computing device 302. Example characteristics can include a sensor configuration, an operating system type, a processing capability, a memory capability, and/or characteristics of a data connection with the user computing device. As an example, the first server computing device can determine that the data format for the second data should include markup languages and/or style sheet languages based on the user computing device being a desktop computer or a laptop computer that is running a web browser application.

At 506, the method 500 can include determining, by the user computing device, an input format for receiving a user input that describes the requested authentication credential, for example as described above with reference to FIGS. 2 through 4.

At 508, the method 500 can include receiving, by the user computing device, the user input according to the input format determined by the user computing device, the user input describing the requested authentication credential, for example as described above with reference to FIGS. 2 through 4.

Additional Disclosure

Specific examples implementations are described below. However, it should be understood that these are merely example implementations and not intended to limit the scope of the present disclosure.

During certain interactions, such as during an online payment, a first online server, such as a shopping site, may authenticate users by presenting security questions from a second online server, such as a bank or a credit issuer. The authentication may allow the identity of the user visiting the first server to be proved to the second server. When the second server provides the questions, security issues may arise. First, in conventional systems, the first server is communicating untrusted HTML to a user on behalf of a third party. HTML, Javascript, and CSS all have vulnerabilities that could be used by either a malicious or compromised third party to attack the user and the user's relationship with the first server.

Additionally, the users often interact with the first server using a variety of devices, such as desktops, laptops, game consoles, smart watches, phones, tablets, voice assistants, and various assistive devices. The first server may be optimized for that context, but the second server might not be, especially as new devices and device types are developed.

The technology disclosed hereon defines semantic elements for 3-D Secure (“3DS”) challenges that are adaptable as HTML5, but can be expressed semantically. 3DS is an XML-based protocol designed to be an additional security layer for online credit and debit card transactions.

The technology disclosed herein will allow issuers to produce, and merchants to render, 3DS challenges in a way that provides strong brand fidelity, is safe in sensitive contexts, can be readily rendered while complying with various platforms standards, and can be readily mapped to HTML or native rendering.

The technology disclosed herein can be used to balance the expressiveness of modern HTML and cascading style sheets (“CSS”) with the complexity of rendering that expressiveness using native elements. The general approach is to identify the subset of HTML and CSS that can meet the above needs, and then convert those to semantic elements.

I. Semantic Elements

Cross-Platform

Example of the technology disclosed herein can achieve various goals, such as consistent branding for the issuer's challenges and consistent user interface (“UI”) experience across the platform.

Rendering is delegated to the platform/software development kit (“SDK”) with requirements to observe guidance from the issuers about color and style. Thus, the logos, colors, and elements of typography can be consistent with issuing brands, but the interaction paradigm, locations of controls, and other aspects of the UI conform to the standards of the platform on which the interaction is happening.

In particular, the technology disclosed herein can provide an appropriate experience regardless of the input/output capabilities of the system, whether a keyboard or a pointer is being used, whether the screen is large or small or absent altogether, whether the user is close or removed (such as 10 feet away), or whether the user is using assistive technologies.

Tab Order

Tab order (if appropriate for the platform) follows the order elements are described in the JavaScript Object Notation (“JSON”) list.

Layout

Layout can be controlled by the SDK, following the EMVCo wireframes, and platform best practices for user input.

Character Encoding

Content can be sent in UTF-8.

Safe Characters

The process defines “safe characters” to be only those characters in [a-zA-Z0-9_:\.\-]. These are the characters in Base64 URL-safe, Base 64 XML name tokens, and Base 64 XML identifiers. Only safe characters may be used for IDs and class names.

Message Layer

In the examples disclosed herein, semantics are described as JSON messages. JSON is well specified, computationally simple, and suited for low power platforms. JSON is well supported in almost every programming language, human readable, easy to debug, technologically mature, and can be widely deployed for communication both inside and between organizations.

Message Structure

The JSON message can contain the following elements:

| Field | Type | Notes |
|---|---|---|
| logoDataUrl | String | data: URL of the image data |
| logoHeight | int | The height of the logo |
| logoWidth | int | The width of the logo |
| learnMore | StyledText | The contents of the learnMore tab |
| help | StyledTest | The contents of the “need some help” |
| | | text block |
| challenge | JSON array of | The array of challenge fields, labels, |
| | SemanticElement | etc. |
| | objects | |
| styles | JSON array of | The array of style settings. |
| | StyleDeclaration | |
| | objects | |

Semantic Elements

This section describes example proposed semantic elements. Following sections show how the elements of HTML and CSS can map to the example semantic elements described in this section.

SemanticElement—Common Attributes

| Field | Type | Notes |
|---|---|---|
| id | String | Optional: if provided it can be unique within |
| | | the challenge and it must contain only safe |
| | | characters |
| style | JSON array | 0 . . . n style names |
| | of strings | |
| type | String | The type of the object - from along the list below. |

StyledText

This element can be used to include styled text for informational blocks, such as “learnMore” or “help”.

| Field | Type | Notes |
|---|---|---|
| type | String | Can be “StyledText” |
| content | String | A string, JSON escaped, with HTML formatting |
| | | using the following tags: <em>, <strong>, <i>, |
| | | <b>, <u> |

Label

This element can be used to specify the label that goes to a particular input element.

| Field | Type | Notes |
|---|---|---|
| type | String | Can be “Label” |
| content | String | A string, JSON escaped, with no HTML tags. |
| for | String | Required: the ID of an input element. |

TextInput

An element:

| Field | Type | Notes |
|---|---|---|
| type | String | Can be “TextInput” |
| name | String | A string comprised of safe characters that will |
| | | be the key used to return the value to the ACS. |
| rendering | String | One of “HIDDEN”, “OBSCURED”, or |
| | | “VISIBLE”. “HIDDEN” means the value |
| | | will be returned on with the response, but not |
| | | displayed or editable by the user. “OBSCURED” |
| | | means that the value will be displayed as the |
| | | platform displays all passwords (usually |
| | | obscured, but sometimes the last character is |
| | | displayed). Some platforms may offer the options |
| | | to unobscure the text. “VISIBLE” means input |
| | | is displayed as it is entered. |
| value | String | Initial value |
| minlength | int | Minimum acceptable length |
| maxlength | int | Maximum acceptable length |
| pattern | String | Reqexp which may match before the value can be |
| | | submitted. Follows HTML5 pattern spec. |
| placeholder | String | The initial “placeholder” value |
| tooltip | String | Help (may not be supported by the platform) |
| required | boolean | Whether a value must be provided |

NumberInput

This element can be to specify the label that goes to a particular input element.

| Field | Type | Notes |
|---|---|---|
| type | String | Can be “NumberInput” |
| name | String | A string comprised of safe characters that will |
| | | be the key used to return the value to the ACS. |
| rendering | String | One of “HIDDEN”, “OBSCURED”, or |
| | | “COARSE”, “PRECISE”. “HIDDEN” |
| | | means the value will be returned on with the |
| | | response, but not displayed or editable by the |
| | | user. “OBSCURED” means that the value |
| | | will be displayed as the platform displays all |
| | | passwords (usually obscured, but sometimes the |
| | | last character is displayed), and users need to |
| | | enter the digits exactly. “PRECISE” means |
| | | that the user needs to enter the digits exactly, |
| | | and otherwise is like “VISIBLE”, and |
| | | “COARSE” means the platform may render |
| | | a slider, a wheel, or whatever platform standard |
| | | element exists to adjust a numeric value visually. |
| value | String | Initial value |
| minlength | int | Minimum acceptable length |
| maxlength | int | Maximum acceptable length |
| min | int | The minimum acceptable value. |
| max | int | The maximum acceptable value. |
| step | int | Only applicable with “COARSE” rendering, |
| | | how much the value should change with each |
| | | coarse adjustment. |
| pattern | String | Reqexp which may match before the value can be |
| | | submitted. Follows HTML5 pattern spec. |
| placeholder | String | The initial “placeholder” value |
| tooltip | String | Help (may not be supported by the platform) |
| required | boolean | Whether a value must be provided |

Similarly for TelephoneInput, EmailInput, YYYYMMDDInput, MMDDInput, HHMMSSInput, HHMMInput, CheckBoxInput, RadioInput, SelectInput.

StyleDeclaration

The styles can be sent as an array of:

| Field | Type | Notes |
|---|---|---|
| selectors | Array of strings | Type selectors: https://drafts.csswg.org/selectors-3/#type-selectors |
| | | Universal selectors; https://drafts.csswg.org/selectors-3/#universal-selector - but only those without name spaces |
| | | Class selectors: https://drafts.csswg.org/selectors-3/#class-html - only using the ‘.’ notation |
| | | ID selectors: https://drafts.csswg.org/selectors-3/#id-selectors - and IDs must be in the id attribute |
| | | Pseudo classes: https://drafts.csswg.org/selectors-3/#pseudo-classes - only the following |
| | | The user action pseudo-classes :hover, :active, and :focus |
| | | https://drafts.csswg.org/selectors-3/#the-user-action-pseudo-classes-hover-act |
| | | :checked - https://drafts.csswg.org/selectors-3/#checked |
| properties | Array of Property | |
| | objects | |

Property

| Field | Type | Notes |
|---|---|---|
| name | String | See list of supported properties |
| value | String | See list of supported values |

II. HTML

General Notes

### Global Attributes

Any HTML element may use the following subset of Global Attributes: id—only including safe characters; class—only including strings of safe characters separated by spaces.

### HTML Elements

Only the following HTML elements may be used in some examples:

Grouping elements
p—with only id and class attributes
div—with only id and class attributes
   Text level elements
em, strong, i, b, u—with no attributes
span—with only id and class attributes

### Embedded Content

img—with only id, class, src, and alt attributes, and src must be a data:// URL.

### Form Elements

Typically, all elements will be rendered inside a form element provided by the 3DS SDK context. Similarly, the accept/cancel/reset buttons can be generated by the SDK, and comply with platform layout standards, but using the visual cues from the CSS.
label—with only id, class, for
input—id, class, tabindex, type, autofocus, list, max, min, step, value, name, maxlength, minlength, placeholder, pattern, title, required
   hidden—only id, name, value
   text—with list, is combo box
      password—no list, no pattern, characters are masked
      telephone
      email
      month
      number
      date
      time
      local date and time
   range
   checkbox
   radio
   select/option

### Styling

Style—inline CSS—no attributes, is assumed to be text/CSS Outstanding issues
Capchas—work best with JS, need audio and video, but they may be provided by the SDK, platform.

III. Cascading Style Sheets

The following aspects of CSS are included in some examples. Following the CSS guidelines, any CSS declaration containing unsupported elements should be completely ignored.

Overview

Content and style should be defined by the ACS, layout should be resolved by the SDK. No reflow from CSS.

Unsupported aspects of CSS

These are just unsupported.
Namespaces
Explicit defaulting: https://drafts.csswg.org/css-cascade-4/#defaulting-keywords

At-Rules

@media—only supports screen, only min-width query allowed. This is to ensure that actual HTML rendering can be responsive.

Selectors

The following selectors are supported selectors in some examples:
Type selectors: https://drafts.csswg.org/selectors-3/#type-selectors
Universal selectors; https://drafts.csswg.org/selectors-3/#universal-selector—but only those without name spaces
Class selectors: https://drafts.csswg.org/selectors-3/#class-html—only using the′.′ notation
ID selectors: https://drafts.csswg.org/selectors-3/#id-selectors—and IDs must be in the id attribute
Pseudo classes: https://drafts.csswg.org/selectors-3/#pseudo-classes—only the following
   The user action pseudo-classes:hover, :active, and:focus https://drafts.csswg.org/selectors-3/#the-user-action-pseudo-classes-hover-act
   checked—https://drafts.csswg.org/selectors-3/#checked

Properties

The following properties are the supported properties in some examples.
background-color
border—but only for these attributes, and all radius values must be expressed in percent.
   border
   border-bottom
   border-bottom-color
   border-bottom-left-radius
   border-bottom-right-radius
   border-bottom-style
   border-bottom-width
   border-color
   border-left
   border-left-color
   border-left-style
   border-left-width
   border-radius
   border-right
   border-right-color
   border-right-style
   border-right-width
   border-spacing
   Border-style
   border-top
   border-top-color
   border-top-left-radius
   border-top-right-radius
   border-top-style
   border-top-width
   border-width
Font—only for the following
   font-family—but fonts will not be downloaded, so renderer to choose best match
   font-size: only absolute-size and relative-size
   font-style
   font-weight
   font-variant-east-asian: QUESTION—is this required for properly rendering
margin—only length, in relative units: em and ex
   margin-bottom
   margin-left
   margin-right
   margin-top
padding—as length
writing-mode

Property Values
Colors
Basic colors: https://www.w3.org/TR/css-color-3/#htm14
RGB: https://www.w3.org/TR/css-color-3/#rgb-color
RGBA: https://www.w3.org/TR/css-color-3/#rgba-color
Transparent: https://www.w3.org/TR/css-color-3/#transparent
Extended colors: https://www.w3.org/TR/css-color-3/#svg-color
Line styles
https://drafts.csswg.org/css-backgrounds-3/#typedef-line-style

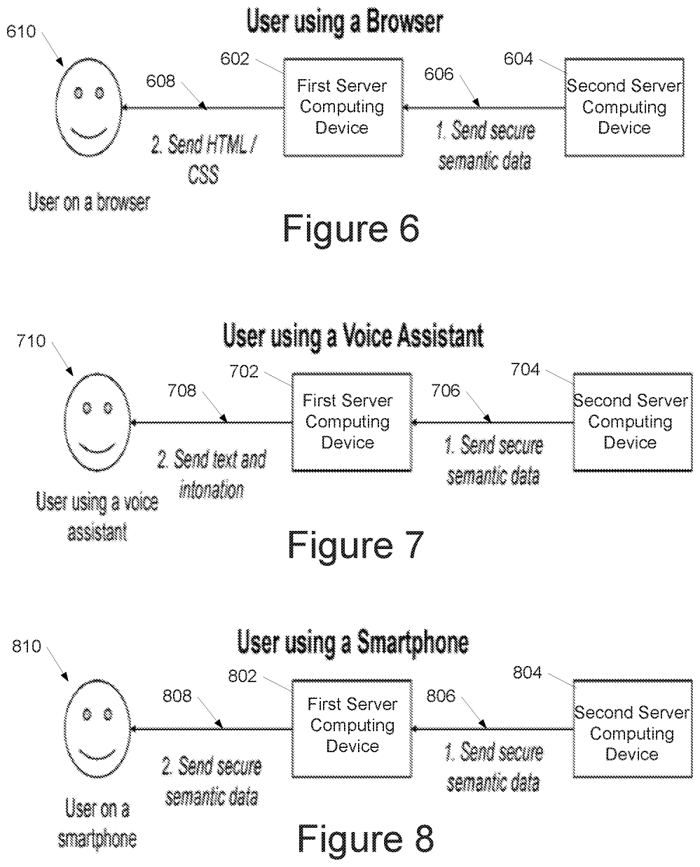

FIG. 6 is a block diagram depicting a first server computing device 602 and a second server computing device 604 communicating secure semantic data 606 to the first server computing device 602. The first server computing device 602 can communicate HTML/CSS data 608 to a user 610 (e.g., to a web browser application running on the user computing device).

FIG. 7 is a block diagram depicting a first server computing device 702 and a second server computing device 704 communicating secure semantic data 706 to the first server computing device 702. The first server computing device 702 can communicate text and intonation data 708 to a user 710 that is using a voice assistant (e.g., to a user voice assistant program of a user computing device).

FIG. 8 is a block diagram depicting a first server computing device 802 and a second server computing device 804 communicating secure semantic data 806 to the first server computing device 802. The first server computing device 802 can communicate secure semantic data 808 to a user 810 using a smartphone.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for obtaining authentication credentials from users, the computing system comprising:
at least one processor;
at least one tangible, non-transitory computer-readable medium that stores instructions that, when executed by the at least one processor, cause the at least one processor to perform operations, the operations comprising:
receiving, at a user computing device from a server computing device, data describing a security query requesting an authentication credential;
determining, by the user computing device, an input format for receiving a user input that describes the requested authentication credential;
receiving, by the user computing device, the user input according to the input format determined by the user computing device, the user input describing the requested authentication credential; and
transmitting, from the user computing device to the server computing device, data describing the requested authentication credential.

2. The system of claim 1, wherein the operations further comprise determining, at the server computing device and based on one or more characteristics of the user computing device, a data format for the data describing the security query that is received at the user computing device from the server computing device.

3. The system of claim 1, further comprising an additional server computing device, and wherein the operations further comprise transmitting additional data describing the requested authentication credential from the server computing device to the additional server computing device, and wherein the additional data describing the requested authentication credential differs from the data describing the security query that is received at the user computing device from the server computing device.

4. The system of claim 3, wherein the operations further comprise:
determining, at the server computing device and based on one or more characteristics of the user computing device, a data format for the data describing the security query that is received at the user computing device from the server computing device; and
generating, at the server computing device, the data describing the security query requesting the authentication credential according to the determined data format.

5. The system of claim 1, wherein determining, by the user computing device, the input format for receiving the user input that describes the requested authentication credential comprises referencing a preferred input format defined by a manufacturer of the user computing device.

6. The system of claim 1, wherein determining, by the user computing device, the input format for receiving the user input that describes the requested authentication credential comprises determining the input format based on a user preference with respect to inputting the user input.

7. The system of claim 1, wherein receiving, by the user computing device, the user input according to the input format determined by the user computing device, the user input describing the requested authentication credential, comprises detecting a movement gesture using a movement sensor of the user computing device.

8. The system of claim 1, wherein the user computing device comprises a plurality of physical buttons, and wherein receiving, by the user computing device, the user input according to the input format determined by the user computing device, the user input describing the requested authentication credential, comprises detecting an input sequence with respect to the plurality of physical buttons.

9. A computer-implemented method for obtaining authentication credentials from users, the method comprising:
receiving, at a user computing device from a server computing device, data describing a security query requesting an authentication credential;
determining, by the user computing device, an input format for receiving a user input that describes the requested authentication credential;
receiving, by the user computing device, the user input according to the input format determined by the user computing device, the user input describing the requested authentication credential; and
transmitting, from the user computing device to the server computing device, data describing the requested authentication credential.

10. The method of claim 9, further comprising:
determining, at the server computing device and based on one or more characteristics of the user computing device, a data format for the data describing the security query that is received at the user computing device from the server computing device; and
generating, at the server computing device, the data describing the security query requesting the authentication credential according to the determined data format.

11. The method of claim 9, further comprising transmitting additional data describing the requested authentication credential from the server computing device to an additional server computing device, and wherein the additional data describing the requested authentication credential differs from the data describing the security query that is received at the user computing device from the server computing device.

12. The method of claim 9, wherein determining, by the user computing device, the input format for receiving the user input that describes the requested authentication credential comprises referencing a preferred input format defined by a manufacturer of the user computing device.

13. The method of claim 9, wherein determining, by the user computing device, the input format for receiving the user input that describes the requested authentication credential comprises determining the input format based on a user preference with respect to inputting the user input.

14. The method of claim 9, wherein receiving, by the user computing device, the user input according to the input format determined by the user computing device, the user input describing the requested authentication credential, comprises detecting a movement gesture using a movement sensor of the user computing device.

15. The method of claim 9, wherein receiving, by the user computing device, the user input according to the input format determined by the user computing device, the user input describing the requested authentication credential, comprises detecting an input sequence with respect to a plurality of physical buttons of the user computing device.

16. A computing system for obtaining authentication credentials from users, the computing system comprising:
at least one processor;
at least one tangible, non-transitory computer-readable medium that stores instructions that, when executed by the at least one processor, cause the at least one processor to perform operations, the operations comprising:
receiving, at a first server computing device from a second server computing device, first data describing a security query requesting an authentication credential;
transmitting, from the first server computing device to a user computing device, second data describing the security query requesting the authentication credential, wherein the first data describing the requested authentication credential comprises secure semantic data that differs from the second data describing the requested authentication credential;
receiving, by the first server computing device, third data describing the requested authentication credential, wherein the third data describing the requested authentication credential is generated by the user computing device based at least in part on a user input according to an input format determined by the user computing device, the user input describing the requested authentication credential; and
transmitting, from the first server computing device to the second server computing device, fourth data describing the requested authentication credential.

17. The system of claim 16, wherein the operations further comprise:
determining, at the first server computing device and based on one or more characteristics of the user computing device, a data format for the second data describing the security query that is received at the user computing device from the first server computing device; and
generating, at the first server computing device, the second data describing the security query requesting the authentication credential according to the determined data format for the second data.

18. The system of claim 16, wherein the operations further comprise:
determining, by the user computing device, an input format for receiving a user input that describes the requested authentication credential; and
receiving, by the user computing device, the user input according to the input format determined by the user computing device, the user input describing the requested authentication credential.

19. The system of claim 18, wherein determining, by the user computing device, the input format for receiving the user input that describes the requested authentication credential comprises referencing a preferred input format defined by a manufacturer of the user computing device.

20. The system of claim 18, wherein determining, by the user computing device, the input format for receiving the user input that describes the requested authentication credential comprises determining the input format based on a user preference with respect to inputting the user input.
